(19) United States
(12) Patent Application Publication
(10) Pub. No.: US 2014/0353413 A1
(43) Pub. Date: Dec. 4, 2014

(54) MULTIPIECE HAMMER FOR HAMMER MILLS

(71) Applicant: Jacobs Corporation, Harlan, IA (US)

(72) Inventor: Chad J. Plumb, Harlan, IA (US)

(21) Appl. No.: 13/903,448

(22) Filed: May 28, 2013

(51) Int. Cl. B02C 13/26; B02C 13/28

(52) U.S. Cl. CPC B02C 13/26; B02C 13/28
USPC 241/194

(57) ABSTRACT

Hammers, including hammer blades, for hammer mills are shown which have an insert bushing press fit into a hole in each hammer blade so that the hammer blades rotate with the bushing around rods being rotated in a circle around a central rotary axis of the rotor of a hammer mill.

### TECHNICAL FIELD

This invention relates generally to a hammer mill apparatus and more particularly to one that uses a bushing that extends between adjacent plates of a hammer mill and has one or more hammers press fit onto the bushing.

### BACKGROUND

Hammers such as those shown in U.S. Pat. No. 7,419,109 to Rondfelt et al. and U.S. Pat. No. 8,104,177 to Plumb need to be replaced periodically. Due to the impact nature of the grinding, the heat treatment of the entire hammer has historically been at low levels to avoid breakage of the hammer. This low level of heat treatment however leads to excessive wear at the hole where the hammer rotates on a hammer mill rod. This phenomenon is sometimes referred to as “hole elongation”. This will also cause excessive wear on the rod itself upon which the hammer rotates about especially once the hammer itself experiences some “hole elongation”.

Another problem is that small particles of the material being ground, such as corn, will tend to build up between the rod and that portion of the hammer forming the hole in the hammer, resulting in excessive premature wear.

Accordingly, there is a need for a solution to the aforementioned problems.

### SUMMARY OF THE INVENTION

The present invention solves the aforementioned problem by using a two piece setup where the rod on which the hammers rotate is covered by a insert or bushing that is replaceable so that the entire hammer does not need to be replaced when the bushing becomes worn. Since the insert/bushing is separate from the hammer blade itself, the hammer blade can be heat treated to different specifications depending upon what it is being used to grind than it could otherwise be treated. For example it can be heat treated to extreme hardness for grinding certain softer materials, not heat treated at all if for application of high impact, or heat treating between very hard and no heating treating at all of the hammers.

The present invention results in a hammer mill hammer blades that do not directly touch the rods that rotate about the central rotational axis of the hammer mill, but instead have an insert bushing pressed into a hole in each hammer blade so that the hammerblade rotate with the bushing around the rods.

This arrangement also permits multiple hammer blades to be placed on one insert/bushing, which greatly decreases installation time for assembly or replacement of hammers onto a hammer mill. These multiple hammers can have spacers between them or can be installed without spacers if desired.

In one embodiment of the invention, an entire hammer rotor slot (the entire distance between two plates of a hammer mill) utilizes a hardened bushing which is pressed inside of multiple hammerblades which can optionally be of the same or of different thicknesses, varying thickness from the grinding end to bushing end allowing for increased/decreased surface area at bushing versus the striking end of the hammer, with or without spacers between adjacent hammers.

By using a bushing or insert that extends completely between (and thereby at least partially sealed) between adjacent plates of a hammer mill, small abrasive particles of the material being ground are kept from lodging between the rod and the bushing, thereby reducing wear on the bushing or insert, reduction in hammers sticking and not rotating on the rod and extending the life of the bushing and the hammer itself.

Other objects, advantages and novel features of the present invention will become apparent from the following detailed description of the invention when considered in conjunction with the accompanying drawings.

### BRIEF DESCRIPTION OF THE DRAWINGS

The above needs are at least partially met through provision of the apparatus described in the following detailed description, particularly when studied in conjunction with the drawings, wherein:

FIG. 1 is a perspective and partially exploded view of a hammer mill rotor constructed in accordance with the present invention;

FIG. 2 is an exploded perspective view of what is shown in the circle of FIG. 1 and labeled “See FIG. 2”;

FIG. 3 is a final assembly of what is shown in FIG. 2 whereby the ends of the bushing would be in abutment with adjacent plates and have five spaced apart hammer blades disposed for rotation together with the bushing around the hammer mill rod;

FIG. 3A is a cross sectional view taken along line 3A-3A of FIG. 3;

FIG. 3B is a cross sectional view taken along line 3B-3B of FIG. 3;

FIG. 4 is an exploded perspective view similar to FIG. 2, but showing that only one hammer blade is disposed on the rod or bushing that is press fit inside of the hole of the hammer shown;

FIG. 5 is an enlarged exploded perspective view of the end of one of the hammers that have a hole in them and a spacer that can be disposed between adjacent hammer blades and/or between a hammer blade and one of the plates shown in FIG. 1;

FIG. 6 is a perspective view of an alternate form of a bushing made of spring steel or the like, which is biased to the diameter shown but which can be squeezed to a smaller diameter for insertion into the hole of a hammer, sort of like a spring steel split ring washer operates, and then released to form a very tight fit with the hammer inside of a hole in a hammer such that the bushing will rotate with the hammer blade about a hammer mill rod; and

FIG. 7 is an exploded perspective view, similar to FIG. 4, showing only one hammer blade is disposed on the rod or bushing that is squeezed to fit inside of the hole of the hammer and spacer shown so that the hammer blade and the bushing rotate together around the rod, the bushing being in a preferred configuration long enough to extend between adjacent plates of the rotor shown in FIG. 1. Of course more than one hammer blade could be placed on the rod or bushing of FIG. 7.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

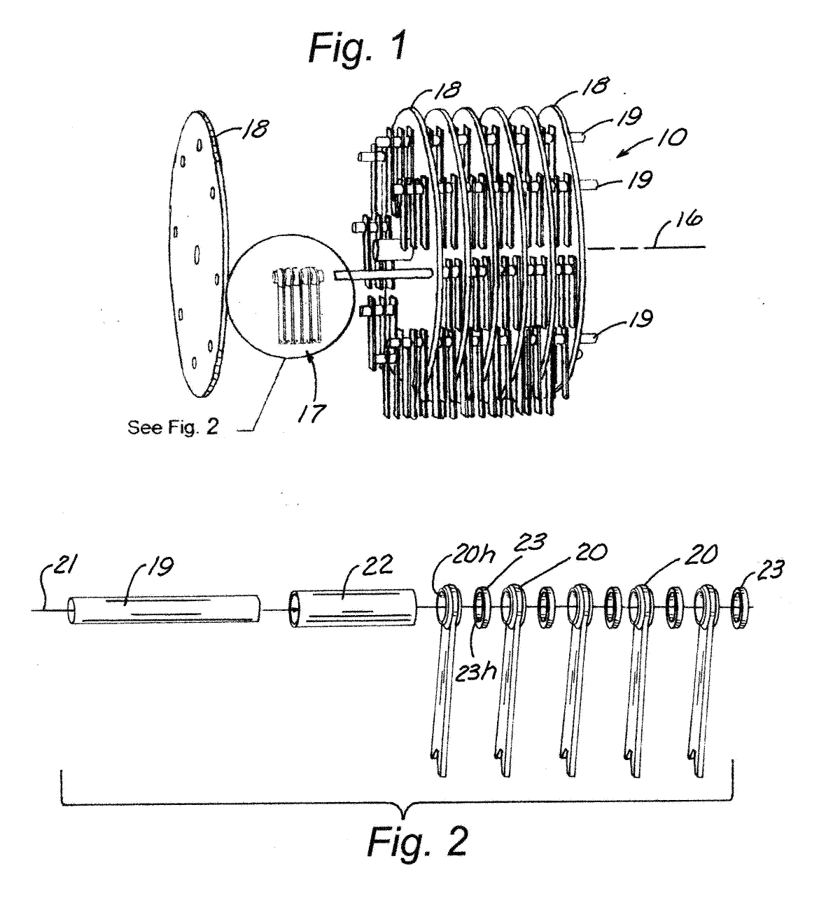

Referring now to the drawings, where like reference numbers designate identical or corresponding views throughout the several views, FIG. 1 shows a hammer mill assembly 10 constructed in accordance with the present invention.

The hammer mill assembly 10 would be disposed for rotary movement inside of a perforated housing (not shown) of the type shown in FIGS. 1 and 2 of U.S. Pat. No. 7,419,109 to Rondfelt et al, which is incorporated herein in its entirety. A rotor 14 is journaled in the perforated housing for rotation about a rotor axis 16. The rotor axis 16 extends through at least a portion of the chamber.

A screen (not shown) is formed by having a plurality of openings in the housing 11 radially outwardly of the rotor 14. The rotor 14 also includes a plurality of plates 18 rigidly attached thereto. Rods 19 are connected to each one of the plates 18 for rotatably attaching hammers 20 thereto via a bushing/insert structure.

The rotor 14 has a plurality of preferably forged hammers 20 disposed in a hammer mill style and also being disposed in groups spaced circumferentially of the rotor 14. The hammer mill assembly 17 of each group of hammers 20 has a common pivot axis 21 that extends transversely of the rotor 14. Each of the pivot axes 21 are spaced respectively equidistantly radially outwardly of the rotor axis 16. Each of the hammer assemblies 17 is proportioned lengthwise thereof for hammer mill style cooperation with the screen upon rotation of the rotor 14. The rotor 14 is rotatable about its journaling axis 16 for grinding and screening through the screen (not shown) for passage to the housing outlet (not shown) so that the material to be reduced in size can be introduced into the housing inlet (not shown). The material can be any material, but corn is a common material that is processed in a hammer mill of the type shown.

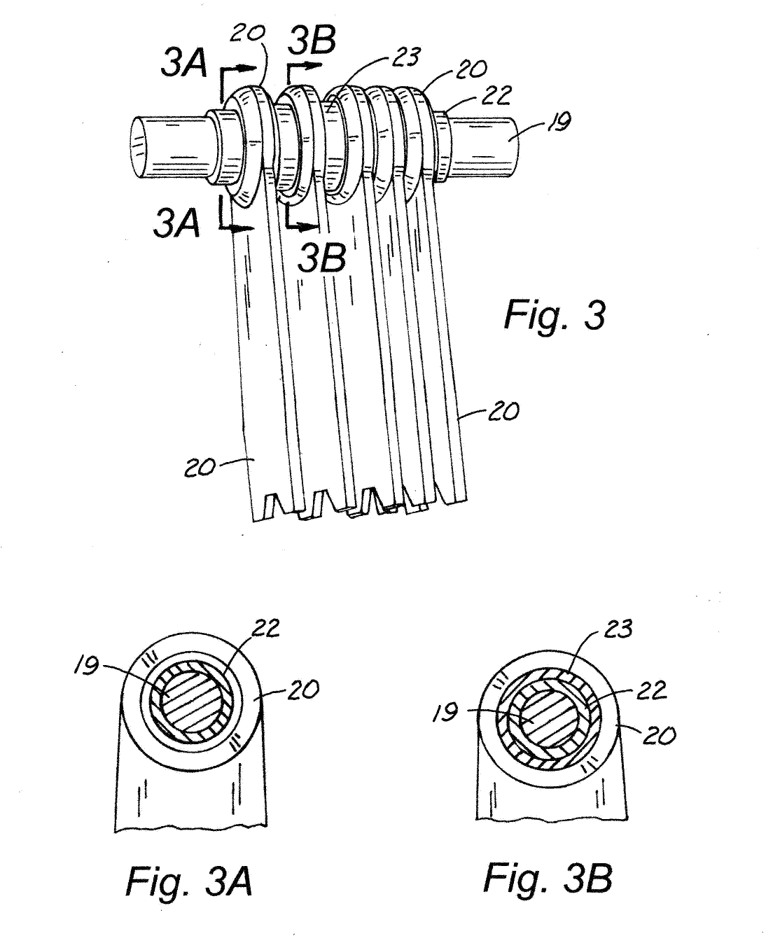

Referring now to FIGS. 2 and 3, a bushing 22 would be press fit into the holes 20h of hammer blades 20 and press fit into the holes 23h of spacers 23 to form the assembly shown in FIG. 3. FIGS. 3A and 3B show the configuration of these just named elements in cross section.

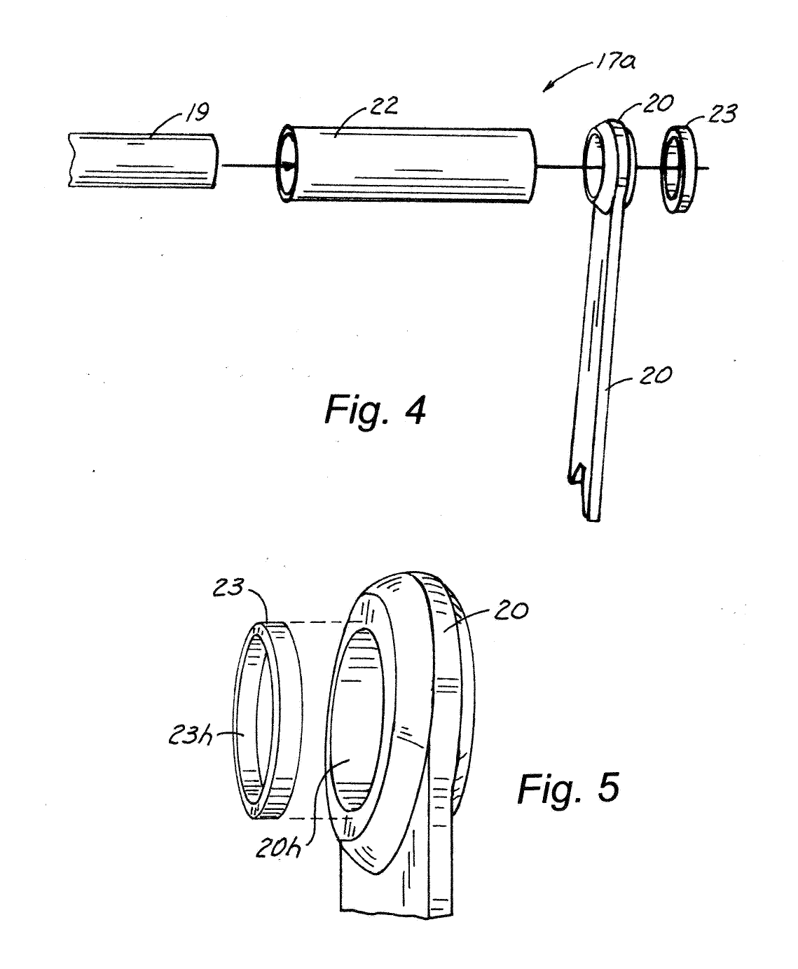

FIG. 4 shows an exploded assembly 17a similar to assembly 17 shown in FIGS. 1, 2 and 3, but having only one hammer blade 20 and only one spacer 23 that are press fit onto the bushing 22, though the spacer could be omitted. It will be understood by those skilled in this art that any number of hammer blades and spacers desired can be placed on the bushing 22 that would be rotatably disposed on rod 19 between adjacent plates 18.

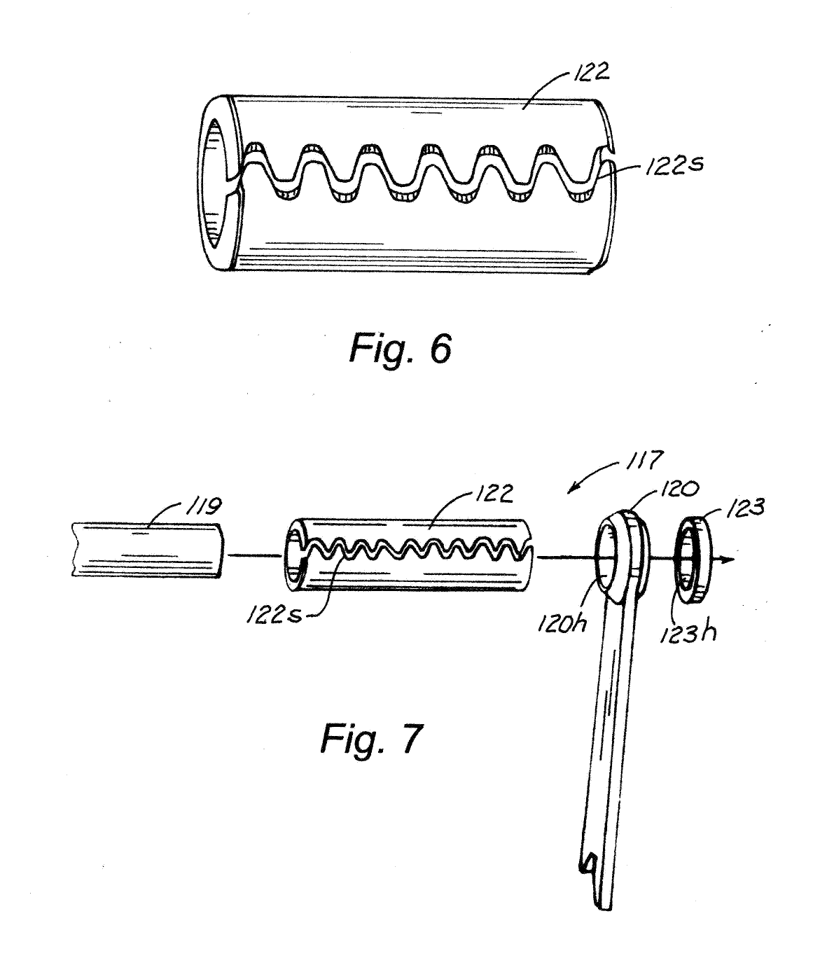

FIG. 6 is a perspective view of an alternate form of a bushing 122 made of spring steel or the like, which is biased to the diameter shown but which can be squeezed to a smaller diameter for insertion into the hole 120h of a hammer 120. The bushing 122, being preferably made similar to a spring steel split ring washer, can be compressed, placed in the hole 120h of a hammer blade 120 and then released to form a very tight fit with the hammer 120 such that the bushing 122 will rotate with the hammer blade 120 about a hammer mill rod 119.

FIG. 7 is an exploded perspective view similar to FIG. 4 showing that only one hammer blade 120 is disposed on the bushing 122 that is squeezed to fit inside of the hole 120h of the hammer blade 120 and spacer 123, with hole 123h therein shown so that the hammer 120 and the bushing 122 rotate together around the rod 119, the bushing 122 being, in a preferred configuration, long enough to extend between adjacent plates 18 of the rotor 10 shown in FIG. 1.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

1. Apparatus comprising:
at least one hammer blade for a hammer mill, said at least one hammer blade having an opening disposed through one end thereof corresponding to a pivot axis, said opening being of a first diameter;
a sleeve having a central opening therein, the sleeve being disposed in said opening in the one end of the at least one hammer blade;
said sleeve having a cylindrical outer surface having a second diameter slightly larger than the first diameter of the opening of the hammer blade, whereby the outer surface of the sleeve is at least initially in a press fit relationship with the inside of the opening of the hammer blade; and
wherein the central opening in the sleeve is of a third inner diameter of a size adapted to be rotatably disposed on a rod of a hammer mill.

2. The apparatus of claim 1 wherein the sleeve is solid throughout the entire periphery thereof.

3. The apparatus of claim 1 wherein the sleeve is made of spring steel and has a space between adjacent edges along a periphery thereof whereby the sleeve has an initial diameter larger than the first diameter of the opening in the hammer blade and can be squeezed to a smaller diameter, inserted into the opening of the hammer blade and then released and move to a larger diameter which forms a tight fit with the inside of the opening in the hammer blade.

4. The apparatus of claim 1 wherein a plurality of hammer blades are disposed on the sleeve.

5. The apparatus of claim 4 wherein a spacer is disposed between each adjacent hammer blade.

6. The apparatus of claim 4 wherein there are five hammer blade on the sleeve.

7. The apparatus of claim 1 wherein the sleeve is disposed on a rod between two plates of a hammer mill, each end of the sleeve being sealed against a respective one of the plates to prevent particles of the material being ground by the hammer mill from lodging between the sleeve and the rod.

8. The apparatus of claim 7 wherein the respective ends of the sleeve are in abutment with respective plates of the hammer mill.

9. The apparatus of claim 7 wherein that part of the hammer blade forming the opening therein is not in contact with the hammer mill rod but instead is in direct contact with the sleeve.
